(19) United States
(12) Patent Application Publication
(10) Pub. No.: US 2025/0208372 A1
(43) Pub. Date: Jun. 26, 2025

(54) OPTICAL ELEMENT DRIVING MECHANISM

(71) Applicant: TDK TAIWAN CORP., Taoyuan City (TW)

(72) Inventors: Yu-Chiao LO, Taoyuan City (TW); Yi-Ho CHEN, Taoyuan City (TW); Chia-Che WU, Taoyuan City (TW)

(21) Appl. No.: 18/989,509

(22) Filed: Dec. 20, 2024

Related U.S. Application Data
(60) Provisional application No. 63/612,581, filed on Dec. 20, 2023.

(51) Int. Cl. G02B 7/08; G02B 27/64

(52) U.S. Cl. CPC G02B 7/08; G02B 27/646

(57) ABSTRACT

An optical element driving mechanism is provided and includes a fixed assembly, a movable assembly and a driving assembly. The movable assembly is configured to connect an optical element, and the movable assembly is movable relative to the fixed assembly. The driving assembly is configured to drive the movable assembly to move relative to the fixed assembly. The fixed assembly includes an accommodating space configured to accommodate the optical element.

### CROSS REFERENCE TO RELATED APPLICATIONS

This application claims the benefit of U.S. Provisional Application No. 63/612,581, filed on Dec. 20, 2023, the entirety of which is incorporated by reference herein.

### BACKGROUND OF THE INVENTION

### Field of the Disclosure

The present disclosure relates to an optical element driving mechanism, and in particular it relates to an optical element driving mechanism with a long focal length and anti-shake functionality.

### Description of the Related Art

As technology has developed, many of today's electronic devices (such as smartphones) have come to be equipped with a camera and video-recording functionality. Using the camera modules disposed in electronic devices, users can operate their electronic devices to capture photographs and record videos.

Today's design of electronic devices continues to follow the trend of miniaturization, meaning that the various components of the camera module and its structure must also be continuously reduced in size, so as to achieve miniaturization. In general, the driving mechanism in a camera module has a camera lens holder configured to hold a camera lens, and the driving mechanism can perform the functions of auto focusing and optical image stabilization. Although existing driving mechanisms can achieve the aforementioned functions needed in photography and video recording, they still cannot meet the needs of users in all respects.

Therefore, how to design a camera module capable of performing autofocus, optical anti-shake functions and achieving miniaturization at the same time are topics nowadays that need to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided. The optical element driving mechanism includes a fixed assembly, a movable assembly, and a driving assembly. The movable assembly is configured to connect an optical element, and the movable assembly is movable relative to the fixed assembly. The driving assembly is configured to drive the movable assembly to move relative to the fixed assembly. The fixed assembly includes an accommodating space configured to accommodate the optical element.

According to some embodiments, the fixed assembly includes a casing and a base. The casing is fixedly connected to the base along a main axis. The casing has a first opening, and when viewed along the main axis, the optical element is exposed from the first opening. The casing has a second opening, and when viewed along a first axis, the optical element is exposed from the second opening. The first opening is connected to the second opening. An external light is emitted into the first opening along an optical axis and then enters the optical element, and then is emitted from the optical element and the second opening along the first axis. The movable assembly includes a first movable part and a second movable part. The first movable part is movably connected to the second movable part. The second movable part is movably connected to the base. The optical element driving mechanism further includes a first elastic member which is connected between the first movable part and the second movable part. The first elastic member has a first connecting terminal, a second connecting terminal and a first flexible portion. The first connecting terminal is fixedly connected to the first movable part, the second connecting terminal is fixedly connected to the second movable part, and the first flexible portion is connected between the first connecting terminal and the second connecting terminal. The optical element driving mechanism further includes a second elastic member which is connected between the second movable part and the base. The second elastic member has a third connecting terminal, a fourth connecting terminal and a second flexible portion. The third connecting terminal is fixedly connected to the second movable part, the fourth connecting terminal is fixedly connected to the base, and the second flexible portion is connected between the third connecting terminal and the fourth connecting terminal. The first elastic member is located on a top side of the movable assembly. The second elastic member is located on a rear side of the movable assembly. The second connecting terminal has a plate-shaped structure and is located on a first plane. The third connecting terminal has a plate-shaped structure located on a second plane. The first plane is not parallel to the second plane.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a three-dimensional schematic diagram of an optical element driving mechanism 100 according to an embodiment of the present disclosure.

FIG. 2 is a schematic exploded diagram of the optical element driving mechanism 100 according to an embodiment of the present disclosure.

FIG. 3 is a perspective view of a partial structure of the optical element driving mechanism 100 in another view according to an embodiment of the present disclosure.

FIG. 4 is a perspective view of a partial structure of the optical element driving mechanism 100 according to an embodiment of the present disclosure.

FIG. 5 is a perspective view of a partial structure of the optical element driving mechanism 100 in another view according to an embodiment of the present disclosure.

FIG. 6 is a three-dimensional cross-sectional view of the optical element driving mechanism 100 along the line A-A in FIG. 1 according to an embodiment of the present disclosure.

FIG. 7 is an enlarged three-dimensional view of a partial structure of the optical element driving mechanism 100 according to an embodiment of the present disclosure.

FIG. 8 is a perspective view of a partial structure of the optical element driving mechanism 100 according to an embodiment of the present disclosure.

FIG. 9 is a cross-sectional view of the optical element driving mechanism 100 along the line B-B in FIG. 1 according to an embodiment of the present disclosure.

FIG. 10 is an exploded diagram of a partial structure of the optical element driving mechanism 100 according to an embodiment of the present disclosure.

FIG. 11 is an exploded diagram of a partial structure of the optical element driving mechanism 100 in another view according to an embodiment of the present disclosure.

FIG. 12 is a cross-sectional view of the optical element driving mechanism 100 along line C-C in FIG. 1 according to an embodiment of the present disclosure.

FIG. 13 is a top view of a partial structure of the optical element driving mechanism 100 according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

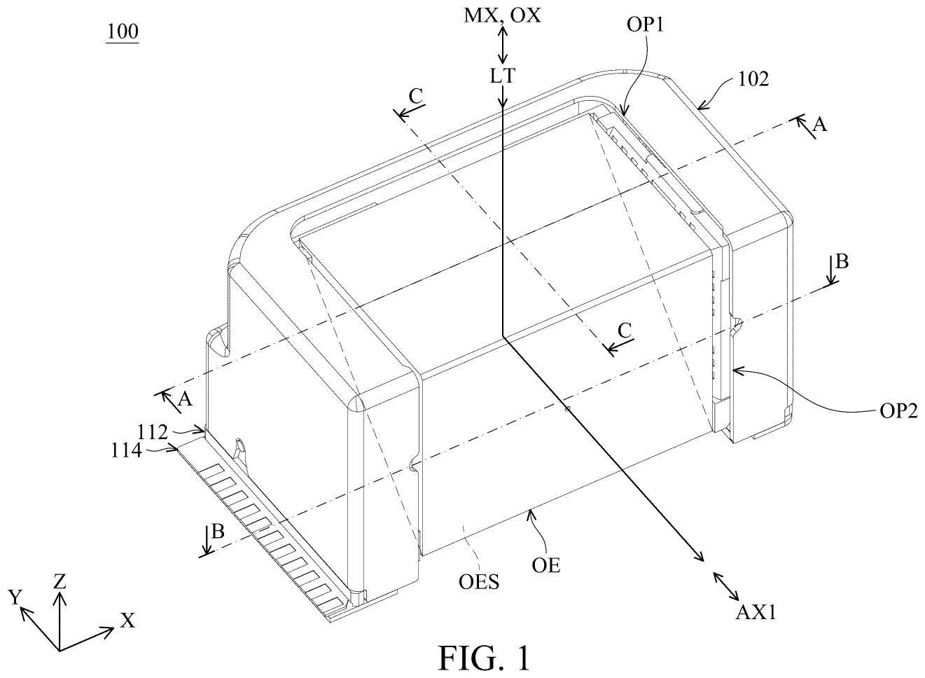

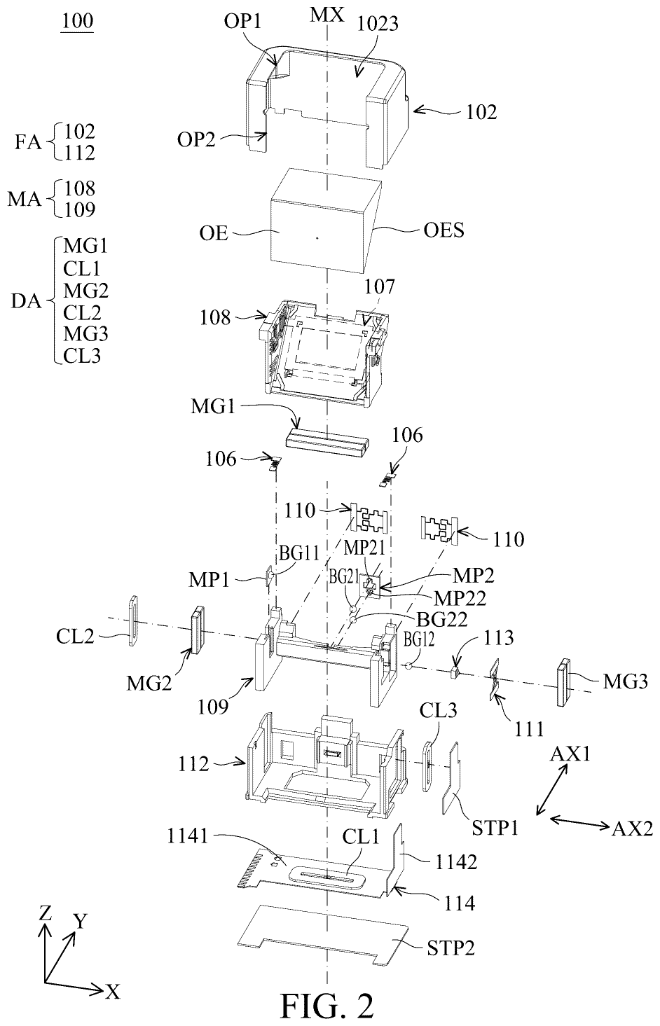

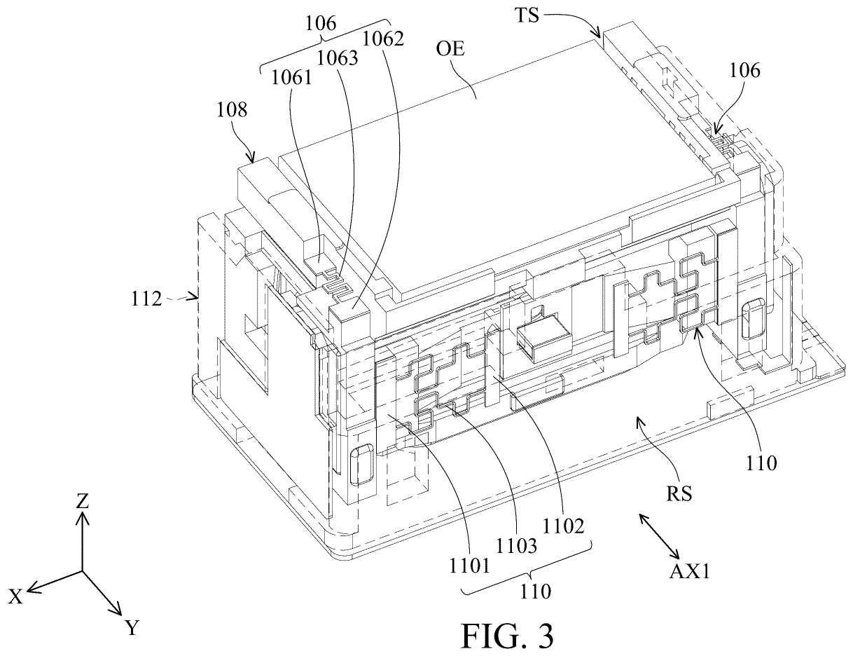

Please refer to FIG. 1 to FIG. 3. FIG. 1 is a three-dimensional schematic diagram of an optical element driving mechanism 100 according to an embodiment of the present disclosure. FIG. 2 is a schematic exploded diagram of the optical element driving mechanism 100 according to an embodiment of the present disclosure, and FIG. 3 is a perspective view of a partial structure of the optical element driving mechanism 100 in another view according to an embodiment of the present disclosure. The optical element driving mechanism 100 may be an optical camera module configured to carry and drive an optical element OE.

The optical element driving mechanism 100 can be installed on various electronic devices or portable electronic devices, such as smart phones, so that users can perform image capturing functions. In this embodiment, the optical element driving mechanism 100 may be a voice coil motor (VCM) with an auto-focus (AF) function, but the present disclosure is not limited thereto. In other embodiments, the optical element driving mechanism 100 may also have automatic focus (AF) and optical image stabilization (OIS) functions.

As shown in FIG. 2, the optical element driving mechanism 100 may include a fixed assembly FA, a movable assembly MA, and a driving assembly DA. The movable assembly MA is configured to connect the aforementioned optical element OE, and the movable assembly MA is movable relative to the fixed assembly FA. The driving assembly DA is configured to drive the movable assembly MA to move relative to the fixed assembly FA.

In this embodiment, the fixed assembly FA includes a casing 102 and a base 112, and the casing 102 is fixedly connected to the base 112 along a main axis MX to form an accommodating space 1023 to accommodate the optical element OE. The casing 102 may have a first opening OP1, and when viewed along the main axis MX, the optical element OE is exposed from the first opening OP1. The optical element OE can be a reflective prism, but it is not limited thereto.

As shown in FIG. 1 and FIG. 2, the casing 102 further has a second opening OP2, and when viewed along a first axis AX1, the optical element OE is exposed from the second opening OP2. The first opening OP1 is connected to the second opening OP2, and an external light LT is emitted into the first opening OP1 along an optical axis OX and then enters the optical element OE, and then is reflected by a reflective surface OES of the optical element OE, and then emitted from the optical element OE and second opening OP2 along the first axis AX1.

In this embodiment, the movable assembly MA may include a first movable part 108 and a second movable part 109. The first movable part 108 is movably connected to the second movable part 109, and the second movable part 109 is movably connected to the base 112.

Specifically, as shown in FIG. 2 and FIG. 3, the optical element driving mechanism 100 may further include two first elastic members 106, which are connected between the first movable part 108 and the second movable part 109. Each of the first elastic members 106 may have a first connecting terminal 1061, a second connecting terminal 1062, and a first flexible portion 1063.

The first connecting terminal 1061 is fixedly connected to the first movable part 108, the second connecting terminal 1062 is fixedly connected to the second movable part 109, and the first flexible portion 1063 is connected between the first connecting terminal 1061 and the second connecting terminal 1062.

Similarly, the optical element driving mechanism 100 further includes two second elastic members 110, which are connected between the second movable part 109 and the base 112. Each of the second elastic members 110 has a third connecting terminal 1101, a fourth connecting terminal 1102 and a second flexible portion 1103.

The third connecting terminal 1101 is fixedly connected to the second movable part 109, the fourth connecting terminal 1102 is fixedly connected to the base 112, and the second flexible portion 1103 is connected between the third connecting terminal 1101 and the fourth connecting terminal 1102.

The first elastic members 106 and the second elastic members 110 may be metal elastic spring sheets, but they are not limited thereto. In addition, the number of first elastic member 106 and second elastic member 110 is not limited thereto embodiment. It is worth noting that the first elastic members 106 is located on a top side TS of the movable assembly MA, and the second elastic members 110 is located on a rear side RS of the movable assembly MA.

As shown in FIG. 3, the second connecting terminal 1062 has a plate-shaped structure and is located on a first plane (such as XY plane), and the third connecting terminal 1101 has a plate-shaped structure and is located on a second plane (such as XZ plane). In this embodiment, the first plane is not parallel to the second plane.

In addition, it should be noted that in FIG. 3, in order to clearly show the configuration of the first elastic members 106 and the second elastic members 110, the base 112 is represented by a dotted line, but it does not mean that the base 112 does not exist.

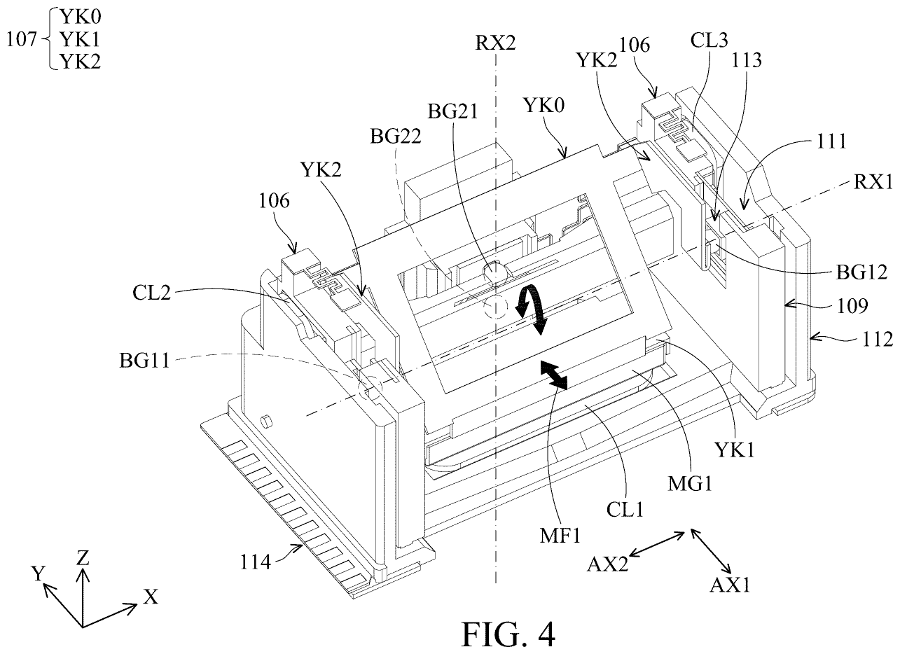

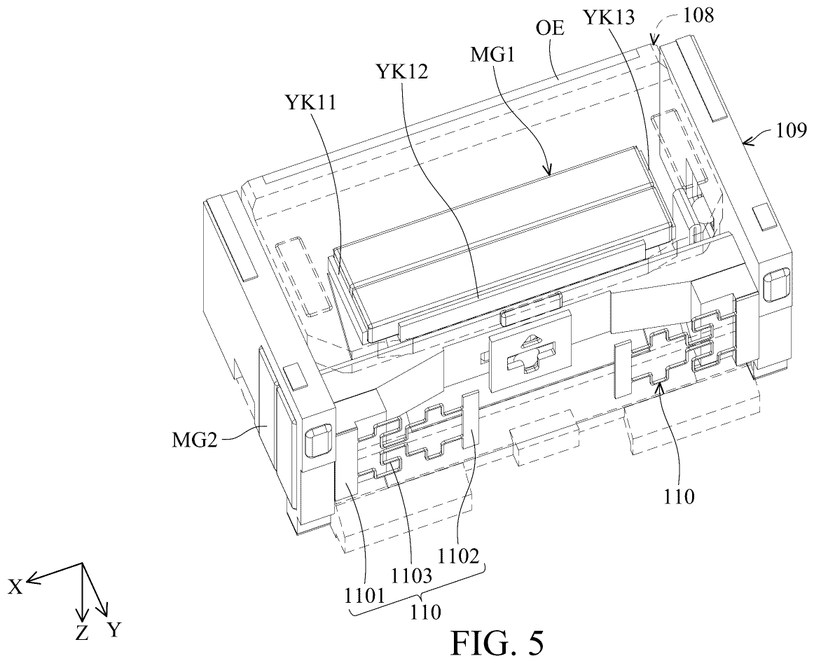

Next, please refer to FIG. 2, FIG. 4 and FIG. 5. FIG. 4 is a perspective view of a partial structure of the optical element driving mechanism 100 according to an embodiment of the present disclosure, and FIG. 5 is a perspective view of a partial structure of the optical element driving mechanism 100 in another view according to an embodiment of the present disclosure. As shown in FIG. 2, the optical element driving mechanism 100 further includes a first reinforcement member 107, which is partially embedded in the first movable part 108.

As shown in FIG. 4, the first reinforcement member 107 may have a reinforced base portion YK0 and a first reinforcement structure YK1, the first reinforcement structure YK1 is fixedly connected to the reinforced base portion YK0, and the reinforced base portion YK0 and at least a portion of the first reinforcement structure YK1 are disposed in the first movable part 108.

As shown in FIG. 4, when viewed along the first axis AX1, the reinforced base portion YK0 is a rectangular frame-shaped structure which is embedded in the first movable part 108. Because the first reinforcement member 107 can be made of metal material, the reinforced base portion YK0 can enhance the overall structural strength of the first movable part 108.

Furthermore, as shown in FIG. 2 and FIG. 4, the driving assembly DA may include a first driving element MG1 and a first coil CL1. The first driving element MG1 is fixedly disposed at the bottom of the first movable part 108.

Correspondingly, the optical element driving mechanism 100 may further include a circuit assembly 114, and the first coil CL1 is disposed on the circuit assembly 114. The circuit assembly 114 is, for example, a flexible printed circuit board (FPC board), but it is not limited thereto.

In this embodiment, as shown in FIG. 4, the first driving element MG1 is configured to act with the first coil CL1 to generate a first electromagnetic driving force MF1 to drive the first movable part 108 to rotate around a first rotating axis RX1 relative to the second movable part 109. For example, the first movable part 108 performs a pitch motion relative to the second movable part 109 and the base 112.

As shown in FIG. 4 and FIG. 5, the first driving element MG1 is disposed on the first reinforcement structure YK1, and a portion of the first reinforcement structure YK1 is located between the first driving element MG1 and the first movable part 108.

It is worth noting that, as shown in FIG. 5, the first reinforcement structure YK1 may have a first side portion YK11, a second side portion YK12 and a third side portion YK13, which are arranged on three sides of the first driving element MG1. The first side portion YK11 is adjacent to the second side portion YK12, and the second side portion YK12 is adjacent to the third side portion YK13.

Because the first reinforcement member 107 can have magnetic permeability, based on the configuration of the first side portion YK11 to the third side portion YK13, the magnetic field strength of the first driving element MG1 can be increased, and the magnetic attraction force is generated between the first driving element MG1 and the first reinforcement structure YK1 to increase the convenience and positioning accuracy of installing the first driving element MG1 on the first reinforcement structure YK1.

Furthermore, as shown in FIG. 2 and FIG. 4, the optical element driving mechanism 100 may further include a first guiding element BG11 and a first guiding element BG12, which are disposed between the first movable part 108 and the second movable part 109 and are configured to guide the first movable part 108 to rotate around the first rotating axis RX1. Specifically, the first rotating axis RX1 is defined by the first guiding element BG11 and the first guiding element BG11, and the first rotating axis RX1 passes through the first guiding element BG11 and the first guiding element BG11.

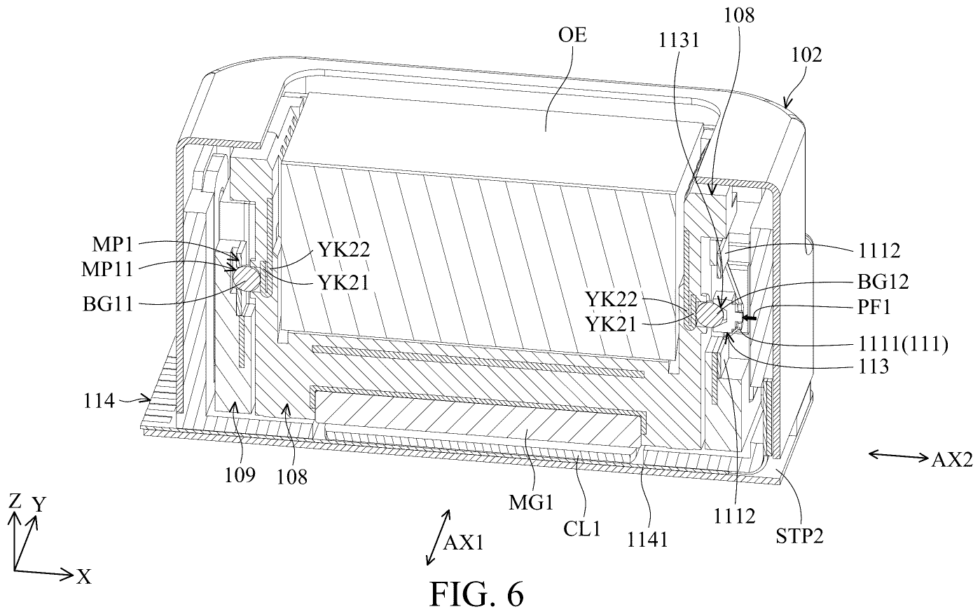

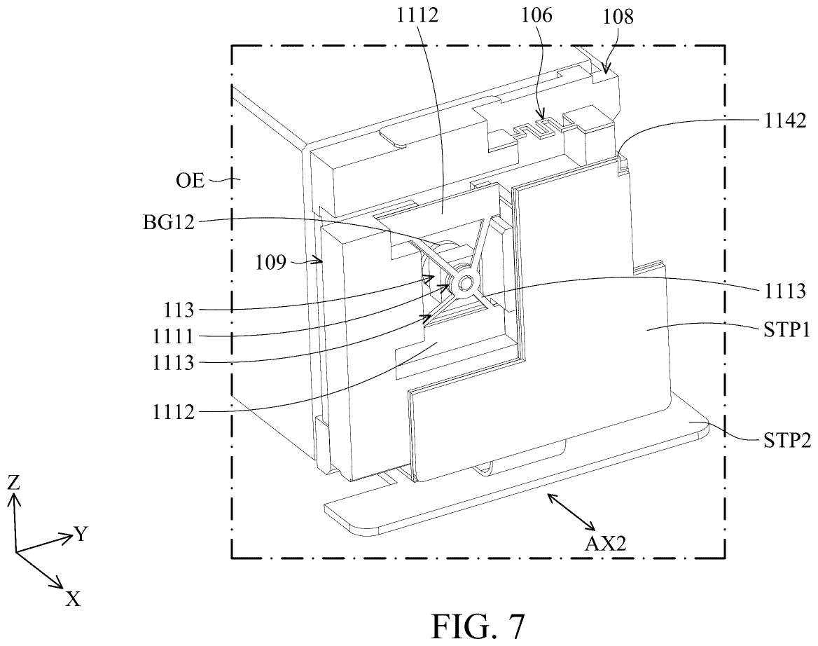

Next, please refer to FIG. 2, FIG. 4, FIG. 6 and FIG. 7. FIG. 6 is a three-dimensional cross-sectional view of the optical element driving mechanism 100 along the line A-A in FIG. 1 according to an embodiment of the present disclosure, and FIG. 7 is an enlarged three-dimensional view of a partial structure of the optical element driving mechanism 100 according to an embodiment of the present disclosure. In this embodiment, the optical element driving mechanism 100 further includes a first plate body MP1, which is fixedly disposed on the second movable part 109. The first plate body MP1 is, for example, a metal sheet body, but it is not limited thereto.

The first plate body MP1 has a first recess MP11 configured to accommodate a portion of the first guiding element BG11. As shown in FIG. 6, a portion of the first guiding element BG11 is accommodated in the first recess MP11.

Furthermore, as shown in FIG. 4 and FIG. 6, the first reinforcement member 107 of the optical element driving mechanism 100 may further include two second reinforcement structures YK2, which are partially disposed in the first movable part 108. The second reinforcement structures YK2 are fixedly connected to the reinforced base portion YK0, and the reinforced base portion YK0 is connected between the two second reinforcement structures YK2.

In this embodiment, the reinforced base portion YK0, the first reinforcement structure YK1 and the second reinforcement structure YK2 can be integrally formed as one pieced, but they are not limited thereto. Furthermore, the first reinforcement member 107 can be a yoke, but it is not limited thereto.

As shown in FIG. 4 and FIG. 6, each of the second reinforcement structures YK2 may have a first contact portion YK21 configured to contact the corresponding first guiding element. The first guiding element BG11 is clamped by the corresponding first contact portion YK21 and the first plate body MP1.

In this embodiment, the first plate body MP1 can be made of metal material, and the first guiding elements BG11 can be made of ceramic material, but they are not limited thereto. In this embodiment, the hardness of the first guiding element BG11 may be greater than the hardness of the first contact portion YK21 or the first plate body MP1. Based on this configuration, the problem of particles generated by friction between the first guiding element BG11 and the first plate body MP1 can be avoided.

It is worth noting that in this embodiment, each of the second reinforcement structures YK2 has a first reinforcement portion YK22, which is connected between the corresponding first contact portion YK21 and the reinforced base portion YK0.

As shown in FIG. 6, when viewed along a second axis AX2, the first contact portion YK21 overlaps the first reinforcement portion YK22, and the second axis AX2 is perpendicular to the first axis AX1.

Because the first movable part 108 can be made of plastic material, based on such a configuration, the structural strength of the side of the first movable part 108 can be enhanced to prevent the first guiding element BG11 from destroying the first movable part 108 due to extrusion.

Next, as shown in FIG. 2, FIG. 6 and FIG. 7, the optical element driving mechanism 100 further includes a force-applying element 111 and a holding member 113. The first guiding element BG12 is located between the first movable part 108 and the holding member 113, and the holding member 113 is located between the force-applying element 111 and the first guiding element BG12.

The force-applying element 111 is connected between the holding member 113 and the second movable part 109, and the force-applying element 111 is made of elastic material, such as elastic metal, but it is not limited thereto. As shown in FIG. 7, the force-applying element 111 has a fifth connecting terminal 1111, two sixth connecting terminals 1112 and a third flexible portion 1113.

The fifth connecting terminal 1111 is fixedly connected to the holding member 113, the sixth connecting terminal 1112 is fixedly connected to the second movable part 109, and the third flexible portion 1113 is connected between the fifth connecting terminal 1111 and the sixth connecting terminal 1112.

As shown in FIG. 6, the holding member 113 has a holding groove 1131 configured to accommodate at least a portion of the first guiding element BG12. In this embodiment, the first guiding element BG12 is fixedly disposed on the first movable part 108 and can move in the holding groove 1131 relative to the holding member 113.

As shown in FIG. 6, in this embodiment, the force-applying element 111 has a preload force PF1, which is configured to drive the fifth connecting terminal 1111 to drive the holding member 113 to push the first guiding element BG12, so that the first guiding element BG12 is in contact with the first movable part 108.

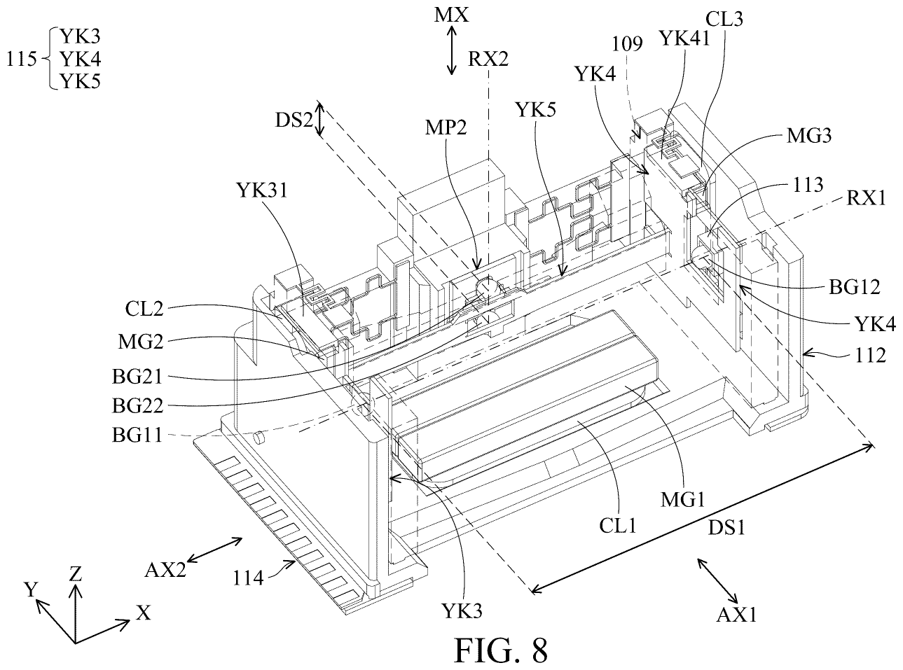

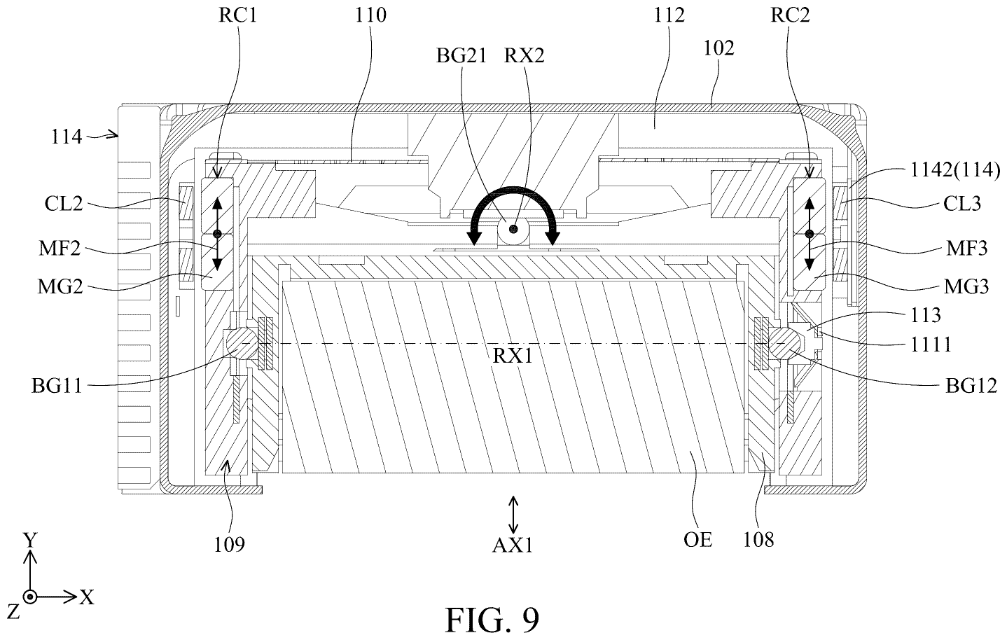

Next, please refer to FIG. 2, FIG. 8 and FIG. 9. FIG. 8 is a perspective view of a partial structure of the optical element driving mechanism 100 according to an embodiment of the present disclosure, and FIG. 9 is a cross-sectional view of the optical element driving mechanism 100 along the line B-B in FIG. 1 according to an embodiment of the present disclosure. It should be noted that in FIG. 8, in order to clearly show the internal structure, the second movable part 109 is represented by a dotted line, but it does not mean that the second movable part 109 does not exist.

In this embodiment, the driving assembly DA may further include a second driving element MG2, a third driving element MG3, a second coil CL2 and a third coil CL3. The second driving element MG2 and the third driving element MG3 are disposed on the second movable part 109, and the second coil CL2 is disposed on the base 112. The second coil CL2 can be electrically connected to the circuit assembly 114 through the circuit structure (such as metal wires, not shown in the figures) which is formed in the base 112 by the insert molding technology, and the third coil CL3 is disposed on the circuit assembly 114.

The first driving element MG1, the second driving element MG2 and the third driving element MG3 can be magnets, such as multi-pole magnets, but they are not limited thereto.

As shown in FIG. 8, the optical element driving mechanism 100 may further include a second reinforcement member 115, which is disposed in the second movable part 109. The second reinforcement member 115 may include a third reinforcement structure YK3 and a fourth reinforcement structure YK4, which are partially disposed in the second movable part 109. The second driving element MG2 is disposed on the third reinforcement structure YK3, and a portion of the third reinforcement structure YK3 is located between the second driving element MG2 and the second movable part 109.

Specifically, the third reinforcement structure YK3 has a fourth side portion YK31, which is disposed on one side of the second driving element MG2. The third reinforcement structure YK3 can be made of metal material and has magnetic permeability, so that the second driving element MG2 can be reliably positioned on the second movable part 109.

Similarly, the third driving element MG3 is disposed on the fourth reinforcement structure YK4, and a portion of the fourth reinforcement structure YK4 is located between the third driving element MG3 and the second movable part 109. The fourth reinforcement structure YK4 has a fifth side portion YK41, which is disposed on one side of the third driving element MG3.

Similarly, because the fourth reinforcement structure YK4 can be made of metal material and has magnetic permeability, the third driving element MG3 can be reliably positioned on the second movable part 109.

As shown in FIG. 9, the second movable part 109 has a first accommodating groove RC1 and a second accommodating groove RC2. The second driving element MG2 is accommodated in the first accommodating groove RC1 and is in contact with the fourth side portion YK31, and the third driving element MG3 is accommodated in the second accommodating groove RC2 and is in contact with the fifth side portion YK41.

Furthermore, the second reinforcement member 115 of the optical element driving mechanism 100 may further include a fifth reinforcement structure YK5, which is partially disposed in the second movable part 109, and the third reinforcement structure YK3 and the fourth reinforcement structure YK4 are fixedly connected to fifth reinforcement structure YK5.

In this embodiment, the fifth reinforcement structure YK5 can be made of metal material, and the third reinforcement structure YK3, the fourth reinforcement structure YK4 and the fifth reinforcement structure YK5 can be integrally formed as one piece, but it is not limited thereto.

It is worth explaining that, as shown in FIG. 9, when viewed along the main axis MX (the Z-axis), the second movable part 109 has a U-shaped structure. Therefore, based on the configuration of the fifth reinforcement structure YK5, it can increase the overall structural strength of the second movable part 109 and avoid damage to the middle part of the second movable part 109 due to movement or impact.

Then, as shown in FIG. 9, the second driving element MG2 is configured to act with the second coil CL2 to generate a second electromagnetic driving force MF2, and the third driving element MG3 is configured to act with the third coil CL3 to generate a third electromagnetic driving force. MF3, so that the second electromagnetic driving force MF2 and the third electromagnetic driving force MF3 can cooperatively drive the first movable part 108 and the second movable part 109 to rotate around a second rotating axis RX2 relative to the base 112.

The directions of the second electromagnetic driving force MF2 and the third electromagnetic driving force MF3 are opposite. For example, when the second electromagnetic driving force MF2 is oriented towards the −Y-axis, the third electromagnetic driving force MF3 is oriented towards the +Y-axis, so that the second electromagnetic driving force MF2 and the third electromagnetic driving force MF3 can cooperatively drive the second movable part 109 and the first movable part 108 to rotate counterclockwise around the second rotating axis RX2.

On the contrary, when the second electromagnetic driving force MF2 is oriented towards the +Y-axis, the third electromagnetic driving force MF3 is oriented towards the −Y-axis, so that the second electromagnetic driving force MF2 and the third electromagnetic driving force MF3 can cooperatively drive the second movable part 109 and the first movable part 108 to rotate clockwise around the second rotating axis RX2.

As shown in FIG. 8, the first rotating axis RX1 is perpendicular to the second rotating axis RX2, the first rotating axis RX1 is perpendicular to the first axis AX1, and the second rotating axis RX2 is parallel to the main axis MX (the Z-axis), but they are not limited thereto.

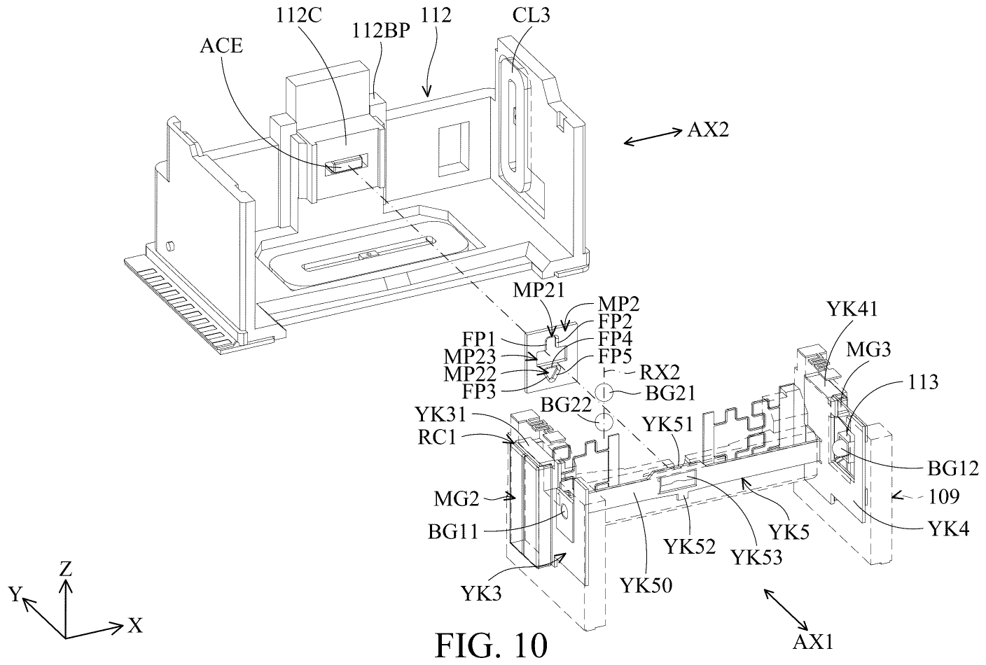

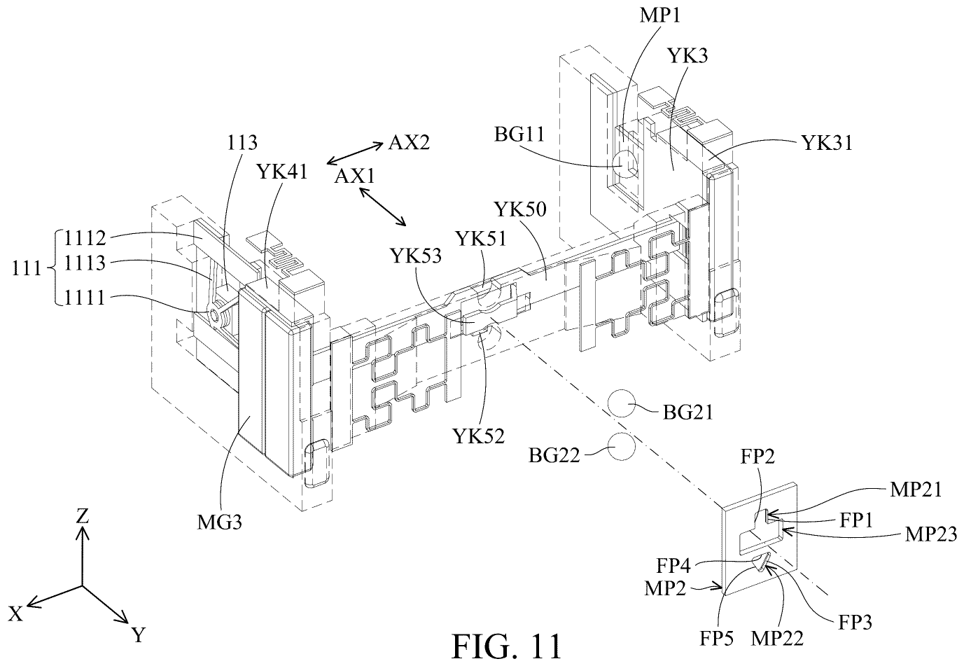

Please refer to FIG. 2, FIG. 8, FIG. 10 to FIG. 11. FIG. 10 is an exploded diagram of a partial structure of the optical element driving mechanism 100 according to an embodiment of the present disclosure, and FIG. 11 is an exploded diagram of a partial structure of the optical element driving mechanism 100 in another view according to an embodiment of the present disclosure. In this embodiment, the optical element driving mechanism 100 may further include a second guiding element BG21 and a second guiding element BG22, which are disposed between the second movable part 109 and the base 112 and are configured to guide the second movable part 109 and the first movable part 108 to rotate around the second rotating axis RX2.

As shown in FIG. 8 and FIG. 10, the second rotating axis RX2 is defined by the second guiding element BG21 and the second guiding element BG22, and the second rotating axis RX2 passes through the second guiding element BG21 and the second guiding element BG22. Furthermore, the optical element driving mechanism 100 further includes a second plate body MP2, which is fixedly disposed on the base 112.

As shown in FIG. 10, when viewed along a second axis AX2, the second guiding element BG21 and the second guiding element BG22 are located between the second movable part 109 and the second plate body MP2

As shown in FIG. 8, in the direction of the second axis AX2, there is a first distance DS1 between the first guiding element BG11 and the first guiding element BG12, in the direction of main axis MX, there is a second distance DS2 between the second guiding element BG21 and the second guiding element BG22, and the second distance DS2 is different from the first distance DS1. In this embodiment, the second distance DS2 is less than the first distance DS1.

As shown in FIG. 10 and FIG. 11, the second plate body MP2 has a second recess MP21 and a third recess MP22, which are configured to accommodate a portion of the second guiding element BG21 and the second guiding element BG22, respectively.

Correspondingly, the fifth reinforcement structure YK5 has a second contact portion YK51 and a third contact portion YK52, which are configured to contact the second guiding element BG21 and the second guiding element BG22 respectively.

Specifically, the second guiding element BG21 is clamped by the second contact portion YK51 and the second plate body MP2, and the second guiding element BG22 is clamped by the third contact portion YK52 and the second plate body MP2.

As shown in FIG. 10, the base 112 has a back plate 112BP and a protruding portion 112C, and the protruding portion 112C is protruded from the back plate 112BP toward the second movable part 109 along the first axis AX1. The optical element driving mechanism 100 may further include an attracting element ACE which is fixedly disposed in the protruding portion 112C. The attracting element ACE is made of magnetic material, such as a magnet, but it is not limited to this.

Furthermore, as shown in FIG. 10 and FIG. 11, the second plate body MP2 has a fourth recess MP23 which is connected to the second recess MP21. As shown in FIG. 10, when viewed along the first axis AX1, the attracting element ACE overlaps the fourth recess MP23. Specifically, when viewed along the first axis AX1, the attracting element ACE is exposed from the fourth recess MP23.

Furthermore, as shown in FIG. 10 and FIG. 11, the second recess MP21 has a first limit surface FP1 and a second limit surface FP2, configured to limit the movement of the second guiding element BG21 along the first axis AX1 and the second axis AX2.

In this embodiment, as shown in FIG. 10, when viewed along the first axis AX1, the first limit surface FP1 may be parallel to the second limit surface FP2, but they are not limited thereto. The first limit surface FP1 and the second limit surface FP2 may be plane surfaces or arc surfaces, but they are not limited thereto.

Similarly, the third recess MP22 has a third limit surface FP3, a fourth limit surface FP4 and a fifth limit surface FP5 configured to limit the movement of the second guiding element BG22 along the first axis AX1, the second axis AX2 and the main axis MX.

In this embodiment, as shown in FIG. 10, when viewed along the first axis AX1, the third limit surface FP3 is not parallel to the fourth limit surface FP4, and when viewed along the first axis AX1, the fourth limit surface FP4 is not parallel to fifth limit surface FP5.

In this embodiment, as shown in FIG. 10 and FIG. 11, when viewed along the first axis AX1, the third limit surface FP3, the fourth limit surface FP4 and the fifth limit surface FP5 can form a triangle, but it is not limited thereto.

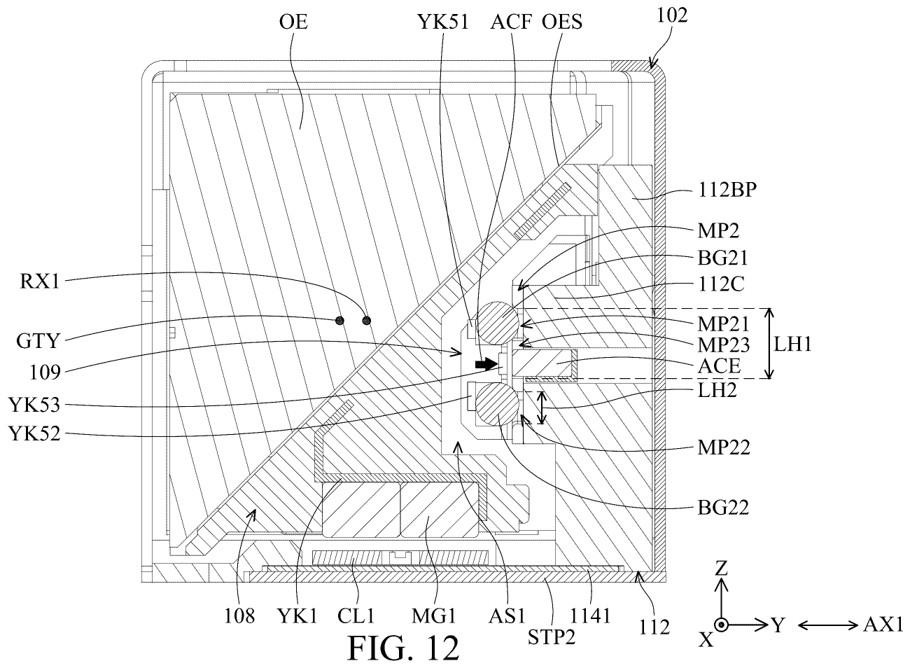

Next, please refer to FIG. 2, FIG. 10 to FIG. 12. FIG. 12 is a cross-sectional view of the optical element driving mechanism 100 along line C-C in FIG. 1 according to an embodiment of the present disclosure. In this embodiment, the first movable part 108 has a first accommodating space AS1, a portion of the second movable part 109 is located in the first accommodating space AS1, and a portion of the protruding portion 112C is located in the first accommodating space AS1.

Furthermore, in this embodiment, the fifth reinforcement structure YK5 can be made of magnetically conductive material, and the fifth reinforcement structure YK5 can have a bending structure YK53 which is located between the second contact portion YK51 and the third contact portion YK52.

As shown in FIG. 10 and FIG. 11, the fifth reinforcement structure YK5 can have a reinforcement body YK50, which is connected between the third reinforcement structure YK3 and the fourth reinforcement structure YK4, and the bending structure YK53 is bent from the reinforcement body YK50.

As shown in FIG. 11, the bending structure YK53 is bent from the reinforcement body YK50 toward the fourth recess MP23, and when viewed along the first axis AX1, a portion of the bending structure YK53 is exposed from the second movable part 109.

Furthermore, as shown in FIG. 12, when viewed along the second axis AX2, a portion of the bending structure YK53 does not overlap the second contact portion YK51 or the third contact portion YK52.

Based on such a configuration, the attracting element ACE can be configured to generate a magnetic attraction force ACF with the bending structure YK53, and the magnetic attraction force ACF is parallel to the first axis AX1.

The magnetic attraction force ACF is configured to drive the fifth reinforcement structure YK5 to drive the second movable part 109 toward the base 112, so that the fifth reinforcement structure YK5 and the second plate body MP2 cooperatively clamp the second guiding element BG21 and the second guiding element BG22.

In this embodiment, as shown in FIG. 12, when viewed along the second axis AX2, a portion of the second guiding element BG21 is located in the fourth recess MP23. When viewed along the second axis AX2, the second recess MP21 and the fourth recess MP23 have a first length LH1.

When viewed along the second axis AX2, the third recess MP22 has a second length LH2, and the first length LH1 is greater than the second length LH2. Based on this configuration, it can avoid the situation where the second guiding element BG21 and the second guiding element BG22 are not accurately clamped between the fifth reinforcement structure YK5 and the second plate body MP2 due to tolerance issues.

In addition, it is worth noting that, as shown in FIG. 12, the first movable part 108 and the optical element OE may cooperatively have a center of gravity GTY, and when viewed along the second axis AX2, the center of gravity GTY and the first rotating axis RX1 are both on the same side of the reflective surface OES (the upper left side in FIG. 12).

Because the center of gravity GTY is closer to the first rotating axis RX1, the torque generated by the center of gravity GTY relative to the first rotating axis RX1 is smaller, so that the first movable part 108 can rotate around the first rotating axis RX1 more stable.

Furthermore, as shown in FIG. 2, the circuit assembly 114 may have a first circuit portion 1141 and a second circuit portion 1142, and the first circuit portion 1141 is connected to the second circuit portion 1142. Correspondingly, the optical element driving mechanism 100 may further include a first reinforcement plate body STP1 which is fixedly connected to the second circuit portion 1142. The first reinforcement plate body STP1 can be made of metal and configured to strengthen the structural strength of the second circuit portion 1142.

Similarly, as shown in FIG. 2 and FIG. 12, the optical element driving mechanism 100 may further include a second reinforcement plate body STP2, which is located on the bottom of the base 112, and the first circuit portion 1141 is located on the second reinforcement plate on body STP2.

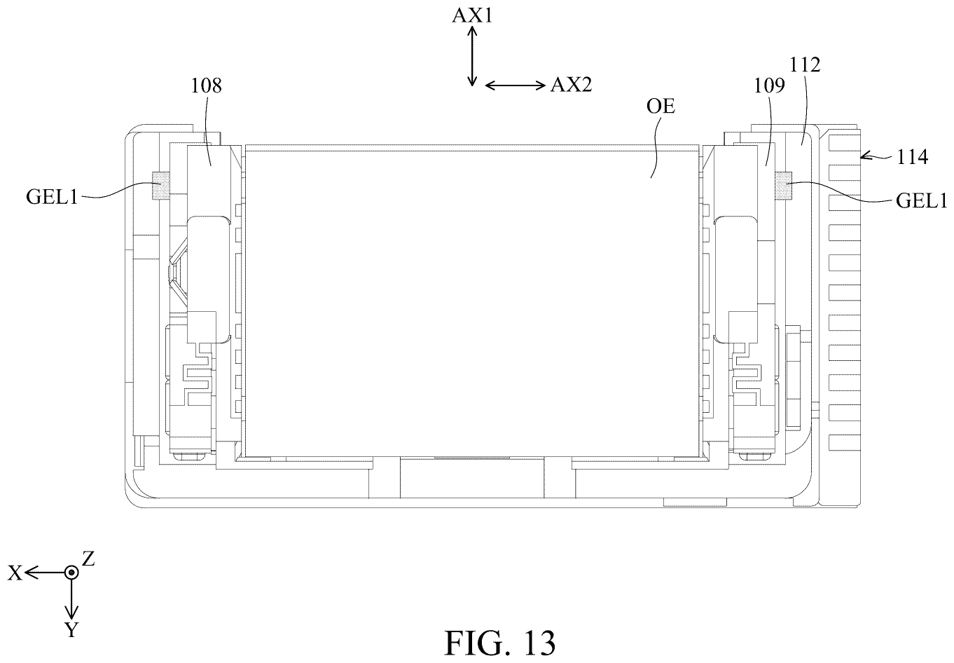

Please refer to FIG. 13, and FIG. 13 is a top view of a partial structure of the optical element driving mechanism 100 according to an embodiment of the present disclosure. In order to ensure the stability of the first movable part 108 and the second movable part 109 when moving, and to prevent the first movable part 108 or the second movable part 109 from colliding with the base 112 when the optical element driving mechanism 100 is impacted, the optical element driving mechanism 100 can further include two adhesive elements GEL1, which are disposed between the second movable part 109 and the base 112.

In this embodiment, the adhesive elements GEL1 may have an elastic material. The adhesive element GEL1 may be gel, for example, but it is not limited thereto. It is worth noting that the adhesive elements GEL1 are not disposed between the first movable part 108 and the second movable part 109.

In addition, as shown in FIG. 13, the adhesive elements GEL1 of this embodiment is arranged in a symmetrical configuration, for example, symmetrically with respect to the first axis AX1 (the central axis), and the optical element OE is located between the two adhesive elements GEL1. Based on such a configuration, the stability of the first movable part 108 and the second movable part 109 during movement can be increased.

The present disclosure provides an optical element driving mechanism 100, which can be a periscope lens mechanism, including a fixed assembly FA, a movable assembly MA, and a driving assembly DA. The movable assembly MA includes a first movable part 108 and a second movable part 109. The first movable part 108 can be flexibly connected to the second movable part 109 through a first elastic member 106, and the second movable part 109 can be movable connected to the base 112 of fixed assembly FA through a second elastic member 110.

The optical element driving mechanism 100 may further include a first guiding element BG11 and a first guiding element BG12, which are disposed between the first movable part 108 and the second movable part 109. The optical element driving mechanism 100 may further include a force-applying element 111 and a holding member 113. The holding member 113 is configured to hold the first guiding element BG12, a portion of the force-applying element 111 is affixed on the second movable part 109, and another portion of the force-applying element 111 is affixed to the holding member 113.

The force-applying element 111 is made of elastic material and is configured to provide a preload force PF1 to drive the holding member 113 to push the first guiding element BG12 so that the first guiding element BG12 contacts the first movable part 108. Based on such a configuration, the first guiding element BG11 and the first guiding element BG12 can be reliably positioned between the first movable part 108 and the second movable part 109, so that the first movable part 108 can stably rotate around the first rotating axis RX1 relative to the second movable part 109.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly:
a movable assembly, configured to be connected to an optical element, wherein the movable assembly is movable relative to the fixed assembly; and
a driving assembly, configured to drive the movable assembly to move relative to the fixed assembly;
wherein the fixed assembly includes an accommodating space configured to accommodate the optical element.

2. The optical element driving mechanism as claimed in claim 1, wherein
the fixed assembly includes a casing and a base;
the casing is fixedly connected to the base along a main axis;
the casing has a first opening, and when viewed along the main axis, the optical element is exposed from the first opening;
the casing has a second opening, and when viewed along a first axis, the optical element is exposed from the second opening; and
the first opening is connected to the second opening;
an external light is emitted into the first opening along an optical axis and then enters the optical element, and then is emitted from the optical element and the second opening along the first axis;
the movable assembly includes a first movable part and a second movable part;
the first movable part is movably connected to the second movable part;
the second movable part is movably connected to the base.

3. The optical element driving mechanism as claimed in claim 2, wherein
the optical element driving mechanism further includes a first elastic member which is connected between the first movable part and the second movable part;
the first elastic member has a first connecting terminal, a second connecting terminal and a first flexible portion; and
the first connecting terminal is fixedly connected to the first movable part, the second connecting terminal is fixedly connected to the second movable part, and the first flexible portion is connected between the first connecting terminal and the second connecting terminal.

4. The optical element driving mechanism as claimed in claim 3, wherein
the optical element driving mechanism further includes a second elastic member which is connected between the second movable part and the base;
the second elastic member has a third connecting terminal, a fourth connecting terminal and a second flexible portion;
the third connecting terminal is fixedly connected to the second movable part, the fourth connecting terminal is fixedly connected to the base, and the second flexible portion is connected between the third connecting terminal and the fourth connecting terminal;
the first elastic member is located on a top side of the movable assembly;
the second elastic member is located on a rear side of the movable assembly;
the second connecting terminal has a plate-shaped structure and is located on a first plane;
the third connecting terminal has a plate-shaped structure located on a second plane; and
the first plane is not parallel to the second plane.

5. The optical element driving mechanism as claimed in claim 4, wherein
the driving assembly includes a first driving element and a first coil;
the first driving element is disposed at the first movable part;
the optical element driving mechanism further includes a circuit assembly, and the first coil is disposed on the circuit assembly; and
the first driving element is configured to act with the first coil to generate a first electromagnetic driving force to drive the first movable part to rotate around a first rotating axis relative to the second movable part.

6. The optical element driving mechanism as claimed in claim 5, wherein
the driving assembly further includes a second driving element, a third driving element, a second coil and a third coil;
the second driving element and the third driving element are disposed on the second movable part;
the second coil is disposed on the base;
the third coil is disposed on the circuit assembly;
the second driving element is configured to act with the second coil to generate a second electromagnetic driving force, and the third driving element is configured to act with the third coil to generate a third electromagnetic driving force, so that the second electromagnetic driving force and the third electromagnetic driving force cooperatively drives the first movable part and the second movable part to rotate around a second rotating axis relative to the base;
the first rotating axis is perpendicular to the second rotating axis;
the first rotating axis is perpendicular to the first axis; and
the second rotating axis is parallel to the main axis.

7. The optical element driving mechanism as claimed in claim 6, wherein
the optical element driving mechanism further includes a reinforced base portion and a first reinforcement structure;
the first reinforcement structure is fixedly connected to the reinforced base portion;
at least a portion of the reinforced base portion and the first reinforcement structure are disposed in the first movable part;
the first driving element is disposed on the first reinforcement structure, and a portion of the first reinforcement structure is located between the first driving element and the first movable part;
the first reinforcement structure has a first side portion, a second side portion and a third side portion, which are arranged on three sides of the first driving element;
the first side portion is adjacent to the second side portion, and the second side portion is adjacent to the third side portion;
the optical element driving mechanism further includes two first guiding elements, which are disposed between the first movable part and the second movable part and are configured to guide the first movable part to rotate around the first rotating axis; and
the first rotating axis passes through the two first guiding elements.

8. The optical element driving mechanism as claimed in claim 7, wherein
the optical element driving mechanism further includes a first plate body, which is fixedly disposed on the second movable part;
the first plate body has a first recess configured to accommodate a portion of the corresponding first guiding element;
the optical element driving mechanism further includes two second reinforcement structures, which are partially disposed in the first movable part;
each of the second reinforcement structures has a first contact portion configured to contact the corresponding first guiding element;
the first guiding element is clamped by the corresponding first contact portion and the first plate body.
each of the second reinforcement structures has a first reinforcement portion, which is connected between the corresponding first contact portion and the reinforced base portion;
when viewed along a second axis, the first contact portion overlaps the first reinforcement portion; and
the second axis is perpendicular to the first axis.

9. The optical element driving mechanism as claimed in claim 8, wherein
the optical element driving mechanism further includes a force-applying element and a holding member;
the corresponding first guiding element is located between the first movable part and the holding member;
the holding member is located between the force-applying element and the corresponding first guiding element;
the force-applying element is connected between the holding member and the second movable part;
the force-applying element is made of elastic material;
the force-applying element has a fifth connecting terminal, a sixth connecting terminal and a third flexible portion; and
the fifth connecting terminal is fixedly connected to the holding member, the sixth connecting terminal is fixedly connected to the second movable part, and the third flexible portion is connected between the fifth connecting terminal and the sixth connecting terminal.

10. The optical element driving mechanism as claimed in claim 9, wherein
the holding member has a holding groove configured to accommodate at least a portion of the corresponding first guiding element; and
the force-applying element has a preload force configured to drive the fifth connecting terminal to drive the holding member to push the corresponding first guiding element so that the first guiding element is in contact with the first movable part.

11. The optical element driving mechanism as claimed in claim 10, wherein
the optical element driving mechanism further includes a third reinforcement structure and a fourth reinforcement structure, which are partially disposed in the second movable part;
the second driving element is disposed on the third reinforcement structure, and a portion of the third reinforcement structure is located between the second driving element and the second movable part;
the third reinforcement structure has a fourth side portion, which is disposed on one side of the second driving element;
the third driving element is disposed on the fourth reinforcement structure, and a portion of the fourth reinforcement structure is located between the third driving element and the second movable part; and
the fourth reinforcement structure has a fifth side portion, which is disposed on one side of the third driving element.

12. The optical element driving mechanism as claimed in claim 11, wherein
the second movable part has a first accommodating groove and a second accommodating groove;
the second driving element is accommodated in the first accommodating groove and is in contact with the fourth side portion; and
the third driving element is accommodated in the second accommodating groove and is in contact with the fifth side portion.

13. The optical element driving mechanism as claimed in claim 12, wherein
the optical element driving mechanism further includes two second guiding elements, which are disposed between the second movable part and the base and are configured to guide the second movable part and the first movable part to rotate around the second rotating axis;
the second rotating axis passes through the two second guiding elements;
the optical element driving mechanism further includes a second plate body, which is fixedly disposed on the base;
when viewed along the second axis, the two second guiding elements are located between the second movable part and the second plate body;
in a direction of the second axis, there is a first distance between the two first guiding elements;
in a direction of the main axis, there is a second distance between the two second guiding elements;
the second distance is different from the first distance; and
the second distance is less than the first distance.

14. The optical element driving mechanism as claimed in claim 13, wherein
the optical element driving mechanism further includes a fifth reinforcement structure which is partially disposed in the second movable part;
the third reinforcement structure and the fourth reinforcement structure are fixedly connected to the fifth reinforcement structure;
the third reinforcement structure, the fourth reinforcement structure and the fifth reinforcement structure are integrally formed as one piece;
the second plate body has a second recess and a third recess, configured to accommodate a portion of the two second guiding elements, respectively;
the fifth reinforcement structure has a second contact portion and a third contact portion configured to contact the two second guiding elements, respectively;
one of the two second guiding elements is clamped by the second contact portion and the second plate body; and
the other of the two second guiding elements is clamped by the third contact portion and the second plate body.

15. The optical element driving mechanism as claimed in claim 14, wherein
the first movable part has a first accommodating space, and a portion of the second movable part is located within the first accommodating space;
the base has a back plate and a protruding portion, and the protruding portion protrudes from the back plate along the first axis toward the second movable part;
a portion of the protruding portion is located in the first accommodating space;
the optical element driving mechanism further includes a attracting element, which is fixedly disposed on the protruding portion;
the attracting element is made of magnetic material; and
the fifth reinforcement structure is made of magnetically conductive material.

16. The optical element driving mechanism as claimed in claim 15, wherein
the fifth reinforcement structure further has a bending structure which is located between the second contact portion and the third contact portion;
when viewed along the second axis, a portion of the bending structure does not overlap the second contact portion or the third contact portion;
the attracting element is configured to generate a magnetic attraction force with the bending structure, and the magnetic attraction force is parallel to the first axis; and
the magnetic attraction force is configured to drive the fifth reinforcement structure to drive the second movable part to move toward the base, so that the fifth reinforcement structure and the second plate body cooperatively clamp the two second guiding elements.

17. The optical element driving mechanism as claimed in claim 16, wherein
the second plate body has a fourth recess which is connected to the second recess;
when viewed along the first axis, the attracting element overlaps the fourth recess;
when viewed along the first axis, the attracting element is exposed from the fourth recess;
the second recess has a first limit surface and a second limit surface configured to limit movement of the corresponding second guiding element along the first axis and the second axis; and
when viewed along the first axis, the first limit surface is parallel to the second limit surface.

18. The optical element driving mechanism as claimed in claim 17, wherein
the third recess has a third limit surface, a fourth limit surface and a fifth limit surface, configured to limit movement of the corresponding second guiding element along the first axis, the second axis and the main axis;
when viewed along the first axis, the third limit surface is not parallel to the fourth limit surface;
when viewed along the first axis, the fourth limit surface is not parallel to the fifth limit surface; and
when viewed along the first axis, the third limit surface, the fourth limit surface and the fifth limit surface form a triangle.

19. The optical element driving mechanism as claimed in claim 18, wherein
when viewed along the second axis, a portion of the corresponding second guiding element is located in the fourth recess;
when viewed along the second axis, the second recess and the fourth recess have a first length;
when viewed along the second axis, the third recess has a second length; and
the first length is greater than the second length.

20. The optical element driving mechanism as claimed in claim 19, wherein
the fifth reinforcement structure has a reinforcement body, which is connected between the third reinforcement structure and the fourth reinforcement structure;
the bending structure is bent from the reinforcement body;
the bending structure is bent from the reinforcement body toward the fourth recess; and
when viewed along the first axis, a portion of the bending structure is exposed from the second movable part.
